(19) United States
(12) Patent Application Publication
(10) Pub. No.: US 2012/0103076 A1
(43) Pub. Date: May 3, 2012

(54) ONLINE-TITRATION IN AN ALTERNATING INSTRUMENT

(75) Inventors: Christina SCHWARZ, Limburgerhof (DE); Chung Huan WONG, Mannheim (DE); Rudolf LEHNIG, Bensheim (DE)

(73) Assignee: BASF SE, Ludwigshafen (DE)

(21) Appl. No.: 13/281,976

(22) Filed: Oct. 26, 2011

Related U.S. Application Data
(60) Provisional application No. 61/407,950, filed on Oct. 29, 2010.

(51) Int. Cl. G01N 1/10; B08B 3/00

(52) U.S. Cl. 73/61.59; 134/113; 73/864

(57) ABSTRACT

Rinsing chamber (10) for an alternating instrument (20) comprising an inlet for rinsing media (11) and an outlet (12), the rinsing chamber (10) furthermore comprising a titration medium inlet (13), a mixing device for mixing liquid contents in the rinsing chamber (10) and a measuring device (15) suitable for determining a quantity relevant for the progress of the titration.

The present invention relates to a rinsing chamber for an alternating instrument comprising an inlet for rinsing media and an outlet. The invention furthermore relates to an alternating instrument with a housing and a dip pipe which is moveable in the housing between an extended sampling position and a retracted measuring position. The invention furthermore relates to a method for determining the concentration of a material or several materials in a measurement product by means of titration in an alternating instrument.

Titration is an absolute analytical method for determining the concentration of a material. In this connection, a titrant which gives an unambiguous reaction with the material to be determined is metered into a sample, the “analyte”. The volume of the titrant added which is necessary for complete equilibration of the reaction in progress to be achieved is determined. This condition is achieved at the “equivalence point”, at which equivalent amounts of sample and titrant have reacted. The amount of the substance to be analyzed can be determined from the amount of titrant used. Several types of titration are known, which differ in the chemical reactions taking place in the titration, such as acid/base titration, redox titration, precipitation titration or complexometric titration. Various methods are known for determining the equivalence point.

One possibility consists in using a color indicator which changes its color as close as possible to the equivalence point and in recording this color change visually or by a measurement technique. Alternative possibilities are based on the recording of a measurable physical variable from which the equivalence point can be inferred, for example using a pH electrode, redox electrode, conductivity probe or photometric probe, with which the absorption of the sample can be determined at a specific wavelength.

Various devices with which a titration can be carried out fully automatically are available commercially. In this connection, the titrant is metered automatically into the analyte and the titration curve is simultaneously recorded with a sensor. The equivalence point of the titration is automatically determined from the titration curve. Such devices calculate the concentration of the analyte from the volume of titrant used up to the achievement of the equivalence point.

In a production process, for example in the chemical or pharmaceutical industry, titrations can be carried out using fully automated process titrators. These devices generally function in online operation, the sample to be determined being conducted through a separate sampling line from an appliance or a process line to the titrator. It is frequently complicated and expensive to construct such sampling lines. A minimum amount of sample has to be available in order to completely fill the sampling lines with sample liquid. In small plants in particular, for example in a pilot plant, it may happen that the volume of the sample available is insufficient or the sample is too valuable to fill sampling lines with it. An additional problem arises with an unstable sample which, on running through the sampling lines, changes so much that the analytical result determined in the process titrator is no longer representative of the conditions prevailing in the appliance or the process line.

It was an object of the invention to make available a titration method for use in a production process in which the abovementioned disadvantages of the sampling are avoided and which can in addition be operated economically and robustly.

This object is achieved according to the invention by a rinsing chamber for an alternating instrument according to claim 1 and an alternating instrument according to claim 5. Furthermore, the object is achieved by a method according to the invention according to claim 8.

In the respective dependant claims, additional advantageous embodiments of the invention are given.

The titration is according to the invention carried out in a rinsing chamber of an alternating instrument. The alternating instrument is advantageously directly attached to part of a plant, for example an appliance or a process line, so that sampling lines known in the state of the art and the problems associated therewith are completely dispensed with. The alternating instrument according to the invention can advantageously be attached to different appliances in which a liquid occurs, for example containers, reactors, columns or heat exchangers. The alternating instrument according to the invention can likewise advantageously be attached to different process lines through which liquid flows, for example lines to, from or between abovementioned appliances, or to lines which lead from a part of a plant to an analyzer.

Alternating instruments are known in principle in process analytics. Thus, the laid-open application DE 10 2006 061 815 A1, for example, describes an alternating instrument with an instrument housing and with a tubular mounting for a sensor led, in the instrument housing, via a reciprocating motion, linearly between a first position and a second position, the sensor determining a physical or chemical process variable. The sensors can be, for example, pH electrodes, amperometric sensors, gas sensors, conductivity sensors or the like.

The tubular mounting mentioned in the laid-open application is subsequently also described as dip pipe. Use is made, for example, of known alternating instruments in order to attach a sensor to a part of a plant so that it can be introduced into a measurement product in the part of a plant and can be led out again without interrupting the process. For example, with pH measurements, regular calibration of the electrode is required. For calibration, the electrode has to be removed from the measurement product. This can be carried out with an alternating instrument in which the pH electrode is used in the dip pipe. The alternating instrument acts as a lock and allows the probe to proceed out of the process into a rinsing chamber which is completely separated from the process. The pH electrode can be cleaned and calibrated in this rinsing chamber.

The present invention makes use of the lock function of an alternating instrument in which the known functions, measuring in the measurement product and rinsing or calibrating in the rinsing chamber, are replaced by the functions, sampling in the measurement product and titration in the rinsing chamber. The rinsing chambers known hitherto are certainly not suitable for this.

In addition to the known inlet for rinsing media and the outlet, a rinsing chamber according to the invention exhibits additional connections. One of these connections is provided as titration medium inlet, through which titration medium can be metered into the rinsing chamber. Use may be made, as titration media, of all media which are also used in conventional process titrators. They are known to a person skilled in the art and are chosen according to the sample to be analyzed. An example is given further below in which the concentration of sodium hydroxide in aqueous solution is determined by metered addition of a hydrochloric acid solution as titration medium. In an additional example, the concentration of hydroxylamine in water is determined by the back titration method, sodium hydroxide being used as titration medium.

An additional connection is provided, in the rinsing chamber according to the invention, for the incorporation of a measuring device. The measuring device can be any type of sensing element or probe which is suitable for determining a quantity relevant for the progress of the titration. Examples of this are pH electrodes, redox electrodes, conductivity probes or photometric probes. In a preferred embodiment, the measuring device comprises an electrochemical measurement sequence for measuring the pH for carrying out acid/base titrations. The pH-sensitive part of this measurement sequence is preferably formed of a glass electrode or an ion-sensitive measurement probe. The ion-sensitive measurement probe is particularly preferably an ion-sensitive field effect transistor, a “ISFET chip”. An ISFET chip offers the advantage of a fast reaction to a change in the pH and accordingly makes possible a short titration time in the context of the method according to the invention.

The rinsing chamber according to the invention is fashioned in such a way that its internal volume is preferably from 10 to 200 ml (milliliters), particularly preferably from 15 to 50 ml, especially from 20 to 30 ml. A choice of the internal volume in one of the preferred ranges proves to be advantageous in this respect as a sufficient amount of the sample to be analyzed can thereby be introduced into the rinsing chamber and space is still sufficiently available for the metered addition of the titration medium, so that the sensing element or the probe of the measuring device remains immersed in the liquid during the whole course of the titration.

The rinsing chamber according to the invention furthermore exhibits a mixing device for mixing liquid contents in the rinsing chamber. In order to prevent local differences in concentration inside the rinsing chamber from resulting in incorrect measurement results, the liquid contents of the rinsing chamber are preferably mixed. In one embodiment, this mixing is done by a micromixer arranged inside the rinsing chamber. In a preferred embodiment, the mixing is carried out by introducing a gaseous mixing medium into the rinsing chamber through an additional inlet. Use is particularly preferably made of an inert mixing medium which reacts chemically neither with the sample nor with the titration medium. Use is made in particular of gaseous nitrogen for mixing the contents of the rinsing chamber. In an advantageous embodiment, the nitrogen is bubbled via a hollow needle into the liquid to be titrated, the gas bubbles being formed resulting in mixing of the liquid. The volumetric flow rate of the inert gas is preferably chosen, depending on the shape and size of the discharge opening, so that the gas bubbles produced exhibit a minimum size for good mixing but do not become so big that the sensing element or the probe is no longer completely covered with liquid. On using a hollow needle with a circular opening with a radius of 0.4 mm as inlet, volumetric flow rates of elemental nitrogen of from 5 to 40 l/h have, for example, proven to be suitable. Particularly good results have been found with a volumetric flow rate of 20 l/h.

The same substances can be used as rinsing media in the apparatus according to the invention as in known process titrators. The choice thereof depends on the type of sample and on the measuring devices used. Use is preferably made of rinsing media which, because of their physical/chemical properties, are suitable for dissolving measurement product adhering to a wall. Use is preferably made for aqueous samples, of completely ionized water as rinsing medium. Should organic constituents occur in the sample, it is advantageous to make use of organic rinsing media in which the organic constituents of the sample dissolve, for example acetone.

If it is helpful or necessary for carrying out the titration, auxiliary media can also be introduced into the rinsing chamber via an inlet. Should, for example, the equivalence point of the titration be established by a change in color of an indicator using a photometric measuring device, the indicator would be an auxiliary medium in the above sense.

An additional subject matter of the invention is an alternating instrument comprising a rinsing chamber according to the invention. The alternating instrument exhibits a housing in which a dip pipe is arranged moveably between an extended sampling position and a retracted measuring position. The rinsing chamber according to the invention is joined to the housing of the alternating instrument. A sampling device is arranged in the dip pipe.

An alternating instrument is usually attached by means of a support to a part of a plant, for example an appliance or a process line. In the alternating instrument according to the invention, the term “extended sampling position” is to be so understood that one end of the dip pipe projects into the part of a plant so that a sample of measurement product can be withdrawn. The term “retracted measuring position” describes a position in the opposite direction, at which the dip pipe is retracted into the housing of the alternating instrument.

In a preferred embodiment, the sampling device exhibits at least one sampling opening and one sample container and is attached in the dip pipe in such a way that, in the withdrawal position, a sample can be withdrawn from a measurement product through the at least one sampling opening, the sample can be taken up in the sample container and, in the measuring position, the sample can be discharged, at least partially, from the sample container into the rinsing chamber through the at least one sampling opening.

The dip pipe has at least one opening at the end which juts into the measurement product in the extended sampling position, so that the measurement product can reach inside the dip pipe. The opening can occur on the front end of the dip pipe or in the pipe wall. In a preferred embodiment, the front end of the dip pipe is closed and the pipe wall exhibits at least one opening.

The sampling device is arranged inside the dip pipe in such a way that, through the opening in the dip pipe, the measurement product can reach the sample container through the sampling opening. The sample container can be completely or partially fitted inside the dip pipe. The sample container can also occur outside the dip pipe and can be connected via a line to the sampling opening in the dip pipe.

The dip pipe and the housing of the alternating instrument are so fashioned that, in the retracted measuring position, the rinsing chamber is sealed off from the measurement product in the part of an appliance. Furthermore, at least one opening of the dip pipe and the sampling opening are positioned in such a way that, in the measuring position, the sample can be discharged, at least partially, from the sample container into the rinsing chamber through the at least one sampling opening.

In an advantageous embodiment of the invention, the sampling device comprises a hollow needle, the hollow tip of which forms the sampling opening and the internal volume of which functions at least partially as sample container. An embodiment in which the sampling device comprises a hollow needle, the lower end of which is closed and which exhibits an opening in the side as sampling opening, the mid point of the opening exhibiting a separation preferably of from 0.5 to 10 mm, particularly preferably of from 0.8 to 5 mm and in particular of from 1 to 3 mm from the lower tip of the hollow needle and the internal volume of the hollow needle functioning at least partially as sample container, has proven to be particularly advantageous. The opening can exhibit different shapes, for example circular, elliptical or rectangular. The opening is preferably circular. The cross-sectional area of the opening is preferably chosen to be not greater than the cross-sectional area of the interior space of the hollow needle, which is defined through a plane perpendicular to the longitudinal axis of the hollow needle. Such a layout of the opening in the hollow needle is then advantageous in particular if the rinsing chamber is rinsed with a rinsing medium while the dip pipe with the hollow needle is in the measuring position. Through the arrangement in the side and the small size of the opening, the probably is markedly reduced of a portion of the sample being discharged from the hollow needle during the rinsing operation and accordingly being lost for the analysis.

The end of the hollow needle opposite the tip is likewise open and connected to a connection of the housing of the alternating instrument. In an advantageous embodiment, the hollow needle is sized in such a way that the whole of the sample necessary for the titration can be taken up in the internal volume of the hollow needle. The withdrawal of the sample can be controlled via the connection in the housing. In an additional advantageous embodiment, the hollow needle is sized in such a way that it can take up only a portion of the sample volume in its interior. In this embodiment, the connection in the housing is joined to a line, for example a flexible hose or rigid pipe section, the internal volume of which is sufficient to take up the remaining portion of the sample volume. In this case, the sample container comprises two structural components, the hollow needle and at least a portion of the line. In a preferred embodiment, the sample is sucked in using a burette, it being possible for the drawn volume of the sample to be exactly determined. The burette can also be used to eject the sample into the rinsing chamber.

An additional subject matter of the invention is a method for determining the concentration of a material or several materials in a measurement product by means of titration in an alternating instrument according to the invention, the method comprising the following stages:
extending the dip pipe into the sampling position,
sampling from the measurement product,
retracting the dip pipe into the measuring position,
introducing the sample into the rinsing chamber,
adding a titration medium until an equivalence point is reached, and
determining the concentration of the sample.

In a preferred embodiment, the rinsing chamber is rinsed with a rinsing medium after the retraction of the dip pipe into the measuring position and before the introduction of the sample into the rinsing chamber. The rinsing medium is subsequently removed from the rinsing chamber. The outlet is preferably arranged on the lowest position of the rinsing chamber viewed in the installed state of the alternating instrument, so that the rinsing medium can be removed from the rinsing chamber simply by opening the outlet. The rinsing agent can also, alternatively or complementarily, be removed from the rinsing chamber by sucking off or expelling with a gas. Measurement product from the current or a previously analyzed sample optionally adhering to a wall of the rinsing chamber, of the dip pipe and/or of the sampling device is removed by the rinsing operation. A defined condition, in particular a defined sample volume, is thereby guaranteed. Through this measure, the accuracy of the titration can be markedly increased. The rinsing operation can, as required, be repeated several times, for example in order to further increase the accuracy or when the sample residue is sparingly soluble in the rinsing medium used.

The achievement of the equivalence point can be established using commercially available devices suitable for fully automatic titrations. These devices normally offer the possibility of determining the concentration of the analyte from the volume of titration medium used up to reaching the equivalence point.

The sequence of the abovementioned stages is not to be regarded as compulsory. Thus, for example, a certain amount of titration medium can be placed in the rinsing chamber before the sample is introduced into the rinsing chamber, so that correspondingly less titration medium has to be added in the next stage until an equivalence point is reached.

In a preferred embodiment of the method according to the invention, the sampling device comprises a hollow needle. In the sampling position, a predefined amount of measurement product is sucked into the internal volume of the hollow needle as sample and, in the measuring position, an additional predefined amount of the sample is introduced into the rinsing chamber.

The amount of measurement product sucked in particularly preferably agrees with the amount introduced into the rinsing chamber within the limits of the accuracy of the measurements. The amount introduced into the rinsing chamber is advantageously from 0.1 to 10 ml, particularly preferably from 0.5 to 5 ml and in particular from 0.8 to 1.2 ml.

In an additional preferred embodiment of the method according to the invention, a predefined amount of a substance or of a mixture is introduced into the rinsing chamber. This substance or this mixture is to be chosen so that it reacts neither with the measurement product in the sample nor with the titration medium, so that the result of the titration is not distorted. For example, completely ionized water is suitable in acid/base titrations. The metered addition of the substance or of the mixture preferably takes place as initial charge before introducing the sample. This results in the sensing element or the probe of the measuring device being satisfactorily covered with liquid from the beginning of the titration onwards, even if only a small volume of sample is available. Through this measure, the volumes of the rinsing chamber interior space and of the sample to be withdrawn can be uncoupled in the design and be freely chosen to a large extent.

Furthermore, preference is given to a method according to the invention in which, for the mixing of the sample in the rinsing chamber, a gaseous mixing medium, preferably nitrogen, is introduced into the rinsing chamber.

In comparison with process titrators known from the state of the art, the apparatus according to the invention and the method according to the invention exhibit manifold advantages. By carrying out the titration in the alternating instrument directly on the process, lines necessary in the conventional procedure are dispensed with, which reduces installation costs. In addition to conspicuous cost advantages, the short routes also result in it being possible to shorten the time periods between analyses. Providing analytical results in shorter time periods can advantageously be used for diagnostic purposes or automation applications, such as online control. In addition, the analysis in the immediate vicinity of the process can increase the accuracy of the analysis since the sample barely has the opportunity to change its properties during the transportation to the place of analysis. Furthermore, the amounts required of the sample to be withdrawn from the measurement product can be markedly reduced, which has a positive effect, in particular with valuable measurement products, since the sample after the analysis usually has to be disposed of.

The invention is further explained subsequently from the drawings, the drawings having to be understood as basic illustrations. They do not represent any limitation of the invention, for example with regard to concrete measurements or alternative embodiments.

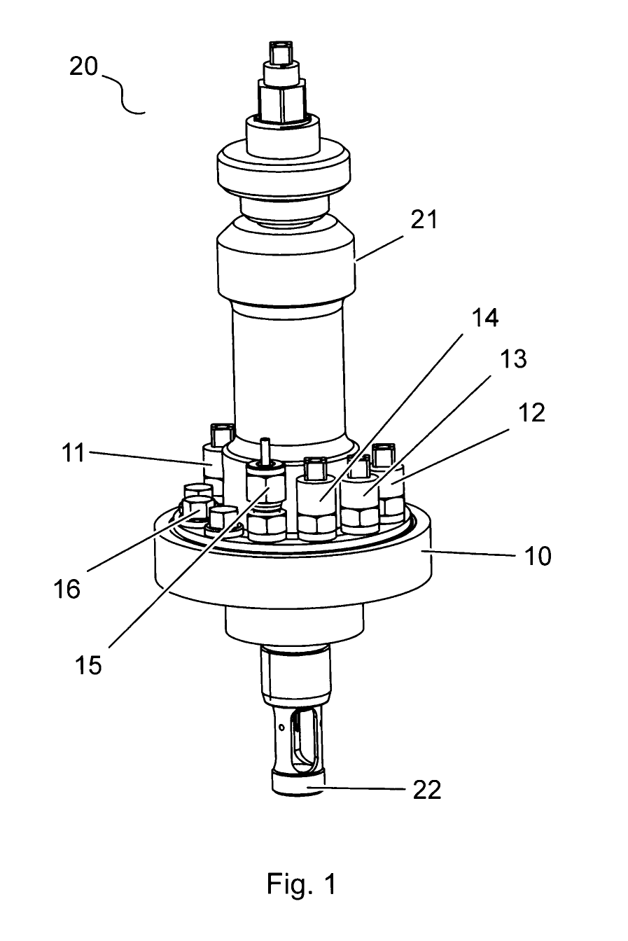

FIG. 1 shows an alternating instrument according to the invention in three-dimensional top view

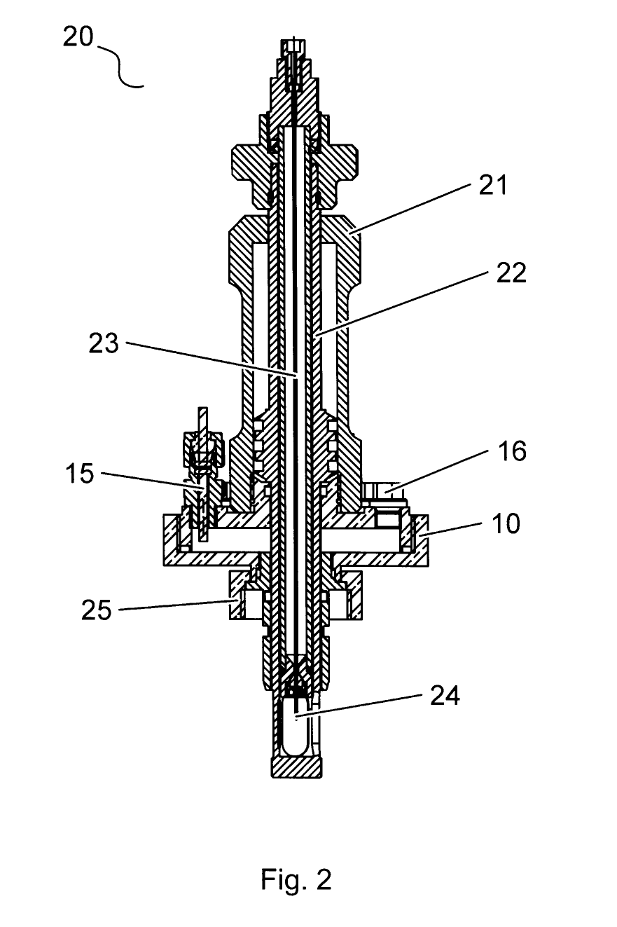

FIG. 2 shows a longitudinal section through an alternating instrument according to the invention in the sampling position

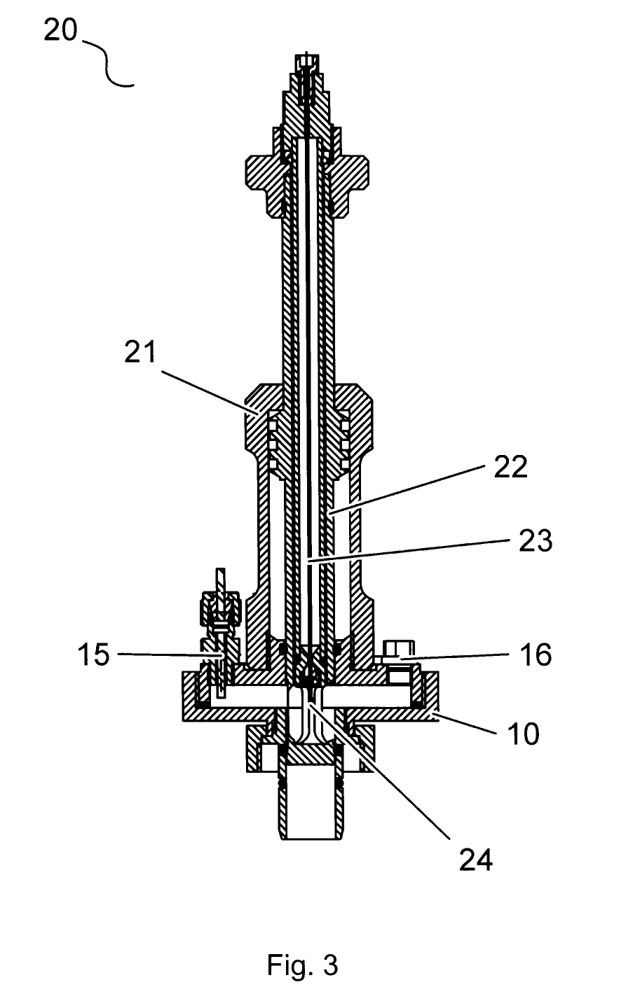

FIG. 3 shows a longitudinal section through an alternating instrument according to the invention in the measuring position.

### LIST OF THE REFERENCE NUMBERS USED

10 . . . rinsing chamber

11 . . . inlet for rinsing media

12 . . . outlet

13 . . . titration medium inlet

14 . . . inlet for mixing medium

15 . . . measuring device

16 . . . blind plugs

20 . . . alternating instrument

21 . . . housing of the alternating instrument

22 . . . dip pipe

23 . . . sampling device

24 . . . sampling opening

25 . . . process connecting device

FIG. 1 shows a preferred embodiment of an alternating instrument 20 according to the invention in the uninstalled state in three-dimensional top view. A rinsing chamber 10 according to the invention is joined firmly to the housing 21 of the alternating instrument. Housing 21 and rinsing chamber 10 are designed essentially cylindrically. The diameter of the rinsing chamber 10 is, in comparison with the diameter of the housing 21, chosen to be so much greater that inlets and outlets can be arranged on the upper side of the rinsing chamber 10 protruding outwards radially from the housing 21. The upper side of the rinsing chamber 10 exhibits in this example more inlets and outlets than are required for the operation of the alternating instrument 20 according to the invention. The openings not needed are tightly closed by blind plugs 16.

The rinsing chamber exhibits an inlet 11 for rinsing media and an outlet 12, and in addition a titration medium inlet 13, an inlet 14 for a mixing medium and a measuring device 15. The connections for rinsing media, titration medium and mixing medium are designed in such a way that hose or pipe connections used by manufacturers of fully automatic titrators can be directly connected. The connections can furthermore be provided with additional structural components, for example nozzles or hollow needles, through which, e.g., the mixing medium can be selectively introduced into the rinsing chamber. In the example represented, a hollow needle is inserted into the inlet for the mixing medium 14. The connection for the measuring device 15 is designed in such a way that the rod-shaped measuring device is fixed through two pinched O rings. In addition, these two pinched 0 rings guarantee that the rinsing chamber is sealed off at this position. It can be seen, on the extended dip pipe 22, that it is in the sampling position.

FIG. 2 shows a longitudinal section through the alternating instrument 20 represented in FIG. 1 along a plane through the cylinder axis, the measuring device 15 and an opposing blind plug 16 (lying in FIG. 1 behind the housing 21 and accordingly not visible). The remaining inlets and outlets are accordingly not apparent from the longitudinal section. In this embodiment, a hollow needle is arranged inside the dip pipe 22 as sampling device 23. The lower end of the hollow needle is closed and the sampling opening 24 is located in the side wall of the hollow needle at a distance of approximately 1 mm from the lower tip of the hollow needle. The dip pipe 22 is designed closed at its lower end. Nevertheless, so that a sample of the measurement product can reach inside the dip pipe, the dip pipe exhibits, in its side, at least one opening just above the lower end. In the example represented, the dip pipe exhibits three openings which are arranged evenly distributed in the circumferential direction. This arrangement has the advantage that, on the one hand, mechanical protection of the sampling device 23 present in the dip pipe 22 is guaranteed and, on the other hand, the measurement product flows around the sampling device 23 with scarcely any limitation. The sampling opening 24 in the hollow needle occurs directly behind the openings in the dip pipe 22.

A process connecting device 25 is provided underneath the rinsing chamber 10 in order to be able to connect the alternating instrument to a part of a plant, e.g. an appliance or a process line. In the example represented, the process connecting device 25 is a cap nut for connection to a threaded flange.

The same longitudinal section through the alternating instrument 20 represented in FIG. 1 is represented in FIG. 3. However, the dip pipe 22 is, in contrast to FIG. 2, in the measuring position. The sampling opening 24 and the openings at the lower end of the dip pipe 22 are now located in the rinsing chamber 10, so that the sample present in the sampling device 23 can be discharged into the rinsing chamber. The lower closed end of the dip pipe 22 fits tightly against O rings in the housing of the alternating instrument and thus seals off the rinsing chamber 10 from the measurement product on the process side.

### EXAMPLE 1

An application for the titration of a sodium hydroxide solution with hydrochloric acid has been developed. The sodium hydroxide solution to be analyzed comprised organic impurities. The alternating instrument 20 used for this application corresponded to the embodiment represented in FIG. 1 to FIG. 3. The internal volume of the rinsing chamber 10 was 20 ml. A hollow needle closed at its lower end served as sampling device 23. The midpoint of a lateral circular opening with a diameter of 0.4 mm occurred at a distance of 1.2 mm from the lower end of the hollow needle. This needle was connected to a burette via a hose. The burette, the hose and the needle were filled with a mixture of water and acetone. The mixture of water and acetone mentioned here and subsequently was in the ratio of 80 to 20% by volume. For the mixing of the liquid in the rinsing chamber 10, gaseous nitrogen was blown into the liquid phase as mixing medium with a volumetric flow rate of 20 l/h via the inlet 14 provided with a hollow needle. The measuring device 15 for tracking the course of the titration comprised a pH electrode equipped with an ISFET chip as pH-sensitive component. The metered addition of the hydrochloric acid as titration medium, the recording of the titration curve and the determination of the equivalence point from the titration curve were carried out with a conventional automatic titrator. The titration proceeded as follows:

At the beginning, the dip pipe 22 with the sampling device 23 situated therein was in the measuring position. The rinsing chamber 10 was empty. A small amount of air (0.1 ml) was sucked into the needle tip using the burette connected via a hose to the sampling device 23. In this way, a small volume of air was generated at the lower end of the hollow needle in its interior space.

The dip pipe 22 was moved into the sampling position via a pneumatic drive.

Using the burette, a volume of one milliliter was withdrawn as sample from the measurement product by sucking in. The sample volume completely filled the interior space of the hollow needle and partially filled the connecting hose between hollow needle and burette. In this example, the sample container thus comprised the interior space of the sampling device 23 and a portion of the connecting hose. The volume of air sucked in in the first stage guaranteed that the sample was not mixed with the mixture of water and acetone present in the burette.

The dip pipe 22 was moved to the measuring position.

The rinsing chamber 10 was rinsed three times with on each occasion 20 ml of a mixture of water and acetone, in order to clean the dip pipe 22 and the needle tip from sample residues and contaminants. The rinsing medium was sucked off. The organic impurities present in the sample could also be dissolved using acetone in the rinsing medium. 10 ml of a mixture of water and acetone were metered into the rinsing chamber 10 as initial charge via the inlet for rinsing media 11. It was thereby guaranteed that the measuring electrode and the hollow needle for the introduction of the nitrogen as mixing medium dipped into the liquid.

The sample present in the sample container was completely discharged into the rinsing chamber 10. Subsequently, 3 ml of the mixture of water and acetone were metered in through the hollow needle acting as sampling device 23, so that no sample residues remained behind in the sample container.

The titration proceeded automatically and was completed when an equivalence point was recognized. The hydrochloric acid consumption or the sodium hydroxide content was determined using the automatic titrator.

The rinsing chamber was rinsed with 20 ml of the mixture of water and acetone as preparation for the next cycle. The rinsing medium was sucked off.

### Example 2

In an additional application, the alternating instrument according to the invention was used to determine the concentration of hydroxylamine in water. Use was made, in this connection, of the back titration method.

Hydroxylamine reacts with sulfuric acid to give hydroxylammonium sulfate. For the determination of the concentration of hydroxylamine in water, sulfuric acid is added in excess to the sample. In order to guarantee that the sulfuric acid is present in excess, the pH of the solution into which the sulfuric acid is being metered is observed, using a pH electrode, during the addition. If a pH of pH=2.8 is achieved, it can be assumed therefrom that sulfuric acid is available in excess. The metered addition of sulfuric acid is completed. The hydroxylamine present in the sample in this connection reacts completely to give hydroxylammonium sulfate. Titration is subsequently carried out with sodium hydroxide. In this titration, a titration curve exhibiting two inflection points is recorded using a pH electrode. The pH electrode used for this step is preferably that which is also used for the measurement of the pH during the addition of sulfuric acid. However, another pH electrode can also be used. The first inflection point of the titration curve marks the complete conversion to sodium sulfate and water of the excess sulfuric acid present in the solution. The second inflection point marks the complete conversion of the hydroxylammonium sulfate to hydroxylammonium hydrogen sulfate and sodium sulfate. The difference in the amounts of sodium hydroxide added which are necessary to achieve the two inflection points of the titration curve corresponds to the amount of hydroxylamine present in the sample. The amounts of sodium hydroxide added can, for example, be easily determined by metering in sodium hydroxide of known concentration via a burette, the amounts metered being recorded.

The alternating instrument 20 used for this application corresponded to the embodiment represented in FIG. 1 to FIG. 3. The internal volume of the rinsing chamber 10 was 20 ml. A hollow needle closed at its lower end served as sampling device 23. The midpoint of a lateral circular opening with a diameter of 0.4 mm occurred at a distance of 1.2 mm from the lower end of the hollow needle. This needle was connected to a burette via a hose. The burette, the hose and the needle were filled with water. For the mixing of the liquid in the rinsing chamber 10, air was blown into the liquid phase as mixing medium with a volumetric flow rate of 10 to 15 l/h via the inlet 14 provided with a hollow needle. The measuring device 15 for tracking the course of the titration comprised a pH electrode equipped with an ISFET chip as pH-sensitive component. The metered addition of a sufficient amount of sulfuric acid as auxiliary medium, of sodium hydroxide as titration medium, the recording of the titration curve, the determination of the inflection points of the titration curve and the calculation of the amount of the hydroxylamine present in the sample were carried out with a conventional automatic titrator. The titration proceeded as follows:

At the beginning, the dip pipe 22 with the sampling device 23 situated therein was in the measuring position. The rinsing chamber 10 was empty. A small amount of air (0.1 ml) was sucked into the needle tip using the burette connected via a hose to the sampling device 23. In this way, a small volume of air was generated at the lower end of the hollow needle in its interior space.

The dip pipe 22 was moved into the sampling position via a pneumatic drive.

Using the burette, a volume of 10 ml was withdrawn as sample from the measurement product by sucking in. The sample volume completely filled the interior space of the hollow needle and partially filled the connecting hose between hollow needle and burette. In this example, the sample container thus comprised the interior space of the sampling device 23 and a portion of the connecting hose. The volume of air sucked in in the first stage guaranteed that the sample was not mixed with the water present in the burette.

The dip pipe 22 was moved to the measuring position.

The rinsing chamber 10 was rinsed once with 30 ml of water, in order to clean the dip pipe 22 and the needle tip from sample residues and contaminants. The rinsing medium was sucked off. The sample present in the sample container was completely discharged into the rinsing chamber 10. Subsequently, 5 ml of water were metered in through the hollow needle acting as sampling device 23, in order to remove all the sample residues from the sample container and to transport them into the rinsing chamber. The titration proceeded automatically and was completed when two inflection points of the titration curve were recognized. The hydroxylamine content was determined using the automatic titrator according to the method described above. The rinsing chamber was rinsed with 30 ml of water as preparation for the next cycle. The rinsing medium was sucked off.

We claim:

1. A rinsing chamber (10) for an alternating instrument (20) comprising an inlet for rinsing media (11) and an outlet (12), the rinsing chamber (10) furthermore comprising a titration medium inlet (13), a mixing device for mixing liquid contents in the rinsing chamber (10) and a measuring device (15) suitable for determining a quantity relevant for the progress of the titration.

2. The rinsing chamber according to claim 1, in which the mixing device comprises an inlet (14) through which a gaseous mixing medium, preferably nitrogen, can be introduced into the rinsing chamber.

3. The rinsing chamber according to either of claims 1 and 2, in which the measuring device (15) comprises a glass electrode or an ion-sensitive measurement probe, in particular an ISFET chip, for determining the pH.

4. The rinsing chamber according to any of claims 1 to 3, the internal volume of the rinsing chamber being from 10 to 200 ml, preferably from 15 to 50 ml and in particular from 20 to 30 ml.

5. An alternating instrument (20) with a housing (21) and a dip pipe (22) which is moveable in the housing (21) between an extended sampling position and a retracted measuring position, the alternating instrument (20) comprising a rinsing chamber (10) according to any of claims 1 to 4 joined to the housing (21) and also comprising a sampling device (23) arranged in the dip pipe (22).

6. The alternating instrument according to claim 5, in which the sampling device (23) exhibits at least one sampling opening (24) and one sample container and is attached in the dip pipe (22) in such a way that, in the sampling position, a sample can be withdrawn from a measurement product through the at least one sampling opening (24), the sample can be taken up in the sample container and, in the measuring position, the sample can be discharged, at least partially, from the sample container into the rinsing chamber (10) through the at least one sampling opening (24).

7. The alternating instrument according to claim 6, in which the sampling device (23) comprises a hollow needle, the lower end of which is closed and which exhibits an opening in the side as sampling opening (24), in which the midpoint of the opening exhibits a separation of from 0.5 to 10 mm, preferably of from 0.8 to 5 mm and in particular of from 1 to 3 mm from the lower tip of the hollow needle and in which the internal volume of the hollow needle functions at least partially as sample container.

8. A method for determining the concentration of a material or several materials in a measurement product by means of titration in an alternating instrument (20) according to any of claims 5 to 7, which comprises the stages:
extending the dip pipe (22) into the sampling position,
sampling from the measurement product,
retracting the dip pipe (22) into the measuring position,
introducing the sample into the rinsing chamber (10),
adding a titration medium until an equivalence point is reached, and
determining the concentration of the sample.

9. The method according to claim 8, in which the sampling device (23) comprises a hollow needle, in the sampling position a predefined amount of measurement product is sucked into the internal volume of the hollow needle as sample and, in the measuring position, an additional predefined amount of the sample is introduced into the rinsing chamber (10).

10. The method according to claim 8 or 9, in which, after the retraction of the dip pipe (22) into the measuring position and before the introduction of the sample into the rinsing chamber (10), the rinsing chamber is rinsed with a rinsing medium and the rinsing medium is subsequently removed from the rinsing chamber (10).

11. The method according to claim 10, in which the rinsing medium is chosen in such a way that it, because of its physical/chemical properties, is suitable for dissolving measurement product adhering to a wall of the rinsing chamber (10), of the dip pipe (22) and/or of the sampling device (23).

12. The method according to any of claims 8 to 11, in which, for the mixing of the sample in the rinsing chamber (10), a gaseous mixing medium, preferably nitrogen, is introduced into the rinsing chamber (10).
